(19) United States
(12) Patent Application Publication
(10) Pub. No.: US 2004/0262489 A1
(43) Pub. Date: Dec. 30, 2004

(54) Adjustable mounting mechanism capable of pan, tilt, roll and their combinations

(75) Inventors: Antony Joseph, Goa (IN); Suryakant Tengali, Goa (IN); Rajachandran Madhan, Goa (IN); Mathen Dias, Goa (IN)

Correspondence Address: MERCHANT & GOULD PC, P.O. BOX 2903, MINNEAPOLIS, MN, 55402-0903, US

(73) Assignee: COUNCIL OF SCIENTIFIC AND INDUSTRIAL, New Delhi (IN)

(21) Appl. No.: 10/607,884

(22) Filed: Jun. 27, 2003

(51) Int. Cl. F16M 1/00

(52) U.S. Cl. 248/646

(57) ABSTRACT

An adjustable mounting mechanism for rigidly mounting devices such as instruments, transducers and so forth, rotating such mounted devices at various angles in the azimuth direction and/or tilting such mounted device at various pitch angles, roll angles and combined pitch-roll angles to permit pan, pitch, roll and combined pitch-roll motion respectively of the device for measurement, simulation and examination of its dynamic performance in multiplicity of ways.

### FIELD OF THE INVENTION

The present invention relates to an adjustable mounting mechanism capable of pan, tilt, roll, and their combinations. More particularly, this invention relates to a novel, fully mechanical, and hand-operated mounting mechanism for (1) rigidly mounting any device (e.g., an instrument, transducer, and so forth) for measurement, simulation, as well as examination of its dynamic performance in any fluid such as air, water, and so forth, (2) rotation of any attached/mounted-device/transducer in the azimuthal direction at any angular intervals to facilitate simulation of pan motions without swinging movement, (3) tilting of any attached/mounted-device/transducer at pitch angles in the front-ward and rear-ward directions to facilitate pitch motions without swinging movement, (4) tilting of any attached/mounted-device/transducer at roll angles in the right-hand and left-hand directions to facilitate roll motions without swinging movement, (5) tilting of any attached/mounted-device/transducer at combined pitch-roll angles in the forward-, rearward-, left-hand, and right-hand-directions to facilitate combined pitch-roll motions without swinging movement, (6) significantly minimizing the influence of drag force during relative motion in any fluid, and (7) directing acoustic/electromagnetic beams in desired fixed orientations, inhibiting their swinging motions.

### BACKGROUND OF THE INVENTION

Motion measuring devices such as current meters for Eulerian- and profile-measurement of water flows in rivers, estuaries, and seas; speed logs used on ships, water scooters, and aircrafts; and wind-measuring devices used on moving platforms such as ships, moored buoys, and drifting buoys need to be tested and calibrated in a dynamic environment such as a tow-tank (for liquid medium) and wind-tunnel (for air medium). Any device that is used for precise measurement of speed of motion needs frequent calibration to ensure the validity of its output data. Additionally, the results of calibration can be used to elucidate the performance characteristics of the device such as accuracy, linearity, azimuthal response, tilt response, and so forth.

Hitherto known adjustable mounting devices capable of tilt motions [Phillips, Jr. (1985), “Outboard Motor Mounting Device and Combinations Therewith”, U.S. Pat. No. 4,548,586] describes an outboard boat motor that utilizes a universal coupling between the upper section of a mounting device that is attached to the hull of a boat and the lower section of the mounting device to which the motor and the impeller are secured. The coupling permits universal lateral pivotal movement of one section relative to the axis of the other section and thus permits the submerged motor assembly to yield with an encountered underwater obstruction. An advantage of this system is that, under a coiled tension spring-loaded mechanism it is amenable to quick automatic lateral movement of the attached device in the event of an impinging force encountered by it, such as when an obstacle hits it so that the possible damage to the attached device is minimized. However, a limitation of this system is that it is simply a protective mechanism, and not a device that is useful for rotating and tilting of an attached device through several specified angles along the azimuth, pitch, roll, and combined pitch-roll directions.

Another system, [E. E. Wheeler, D. C. Wheeler, and W. M. Wheeler (1987), “Pan and Tilt Mount”, U.S. Pat. No. 4,673,268] describes a pan and tilt mount mechanism for a television camera or the like. In this device stepping motors rotate the pan and tilt portions. The pan portion can be continuously rotated in either direction through 360°. An advantage of this system is that the pan and tilt mount is remote positionable. However, a limitation of this system is that it contains a plurality of stepping motors, slip rings (constructed of silver, bronze, copper, platinum, gold, or the like), interconnected brushes, gears, and electrical resistors that need to be submerged in liquid coolant having a low melting temperature to maintain a predetermined operation temperature, as well as the requirement of a computer thereby rendering the device complicated and costly. Although the device might be suitable for mounting a television camera (for which it has been intended), a limitation of this device is that it is unsuitable for use in underwater applications and in situations where relative motion between the fluid medium and the device results in large drag force. Another limitation of this device is that it does not have the capability for tilt under roll and combined pitch-roll orientations.

An alternate system, [D. D. Wergin, and A. L. Wergin (1989), “Transducer Mounting Device”, U.S. Pat. No. 4,875,651 describes a transducer mounting device, and more particularly a transducer mounting device on a hospital operating table, wherein the said device is capable of maintaining a transducer at a constant level in relationship to the patient lying on an operating table regardless of any raising, lowering, tilting or rotating of the operating table that may occur during an operation. In this system, the transducer mounting device is securely fastened to the frame of the operating table and comprises a bar that includes a horizontal arm portion extending along the side of the table and a vertical arm portion extending upward from the end of the horizontal arm portion to provide a mounting surface for the transducer at the level of the patient's heart. The horizontal arm portion is laterally offset from the frame of the operating table to allow clearance space during the initial orientation of the horizontal and vertical arm portions. An advantage of this system is its ability to mount one or more transducers that are being used during a surgical operation to monitor the patient's blood pressure from various test points (e.g., left radial artery, the pulmonary artery, and so forth). Another advantage of this system is avoiding the need to reposition the transducer support on the intravenous pole to maintain the transducer at the exact level of the patient's heart. However, a limitation of this methodology is that it is not suitable for use in applications where the mounted device, instrument, transducer and so forth are liable to be subjected to drag forces that are always encountered in presence of relative motions in fluid mediums. Another limitation of the above system is that it is hard to orient the attached/mounted device, instrument, transducer and so forth in rigidly fixed positive and negative pitch-angles, roll-angles, or combined pitch-roll angles, and rotate the attached/mounted-device in the azimuthal orientations.

Another system, [S. Sakurai, D. W. Hoener, and E. V. Schweizer (1992), “Mechanically-linked side stick controllers with isolated pitch and roll control movement”, U.S. Pat. No. 5,149,023 {assigned to The Boeing Company (Seattle, Wash.)}] describes a device with isolated pitch and roll control movement. This device includes a hand-operated control member that is capable of swinging about two axes of rotation. In this device, a first lever member on the said control member moves in response to swinging movement of this control member about a first axis of rotation. A reciprocating member in this device has a first portion pivotally attached to the previously mentioned control member at a location spaced from the second axis of rotation. The said reciprocating member has an elongated second portion axially movable along a line of reciprocation that is co-axial with the first axis of rotation in response to swinging movement of the previously mentioned control member about a second axis of rotation. The movements of the first lever member and the reciprocating member are used to effect operation of a first control sensor and a second control sensor respectively, wherein the said control sensors include the means for translating mechanical motions into corresponding electrical signals through the use of rotary variable differential transformers (commonly known and function as electrical position sensors). An advantage of this system is its ability to accomplish isolation of input movement (specifically, pitch and roll control movement) between two axes and permitting simultaneous mechanical linking of a pair of controllers. This ability renders it suitable for use as side stick controllers in aircraft or flight simulators for control of remote air foil, primarily for those systems known as “fly-by-wire”, wherein the associated hydraulic valve and actuator are controlled by electrical signals. However, a limitation, of this device is that its mechanical linkages include a plurality of connecting rods and crank arms, which renders it complex and complicated in applications such as simulation/measurement/examination of the dynamic performance of instruments, transducers, and so forth. Another limitation of this device is its inability to perform tilts under combined pitch-roll orientations avoiding swinging motions.

Yet another system [M. Muzila (2002), “Adjustable Camera Mounting Device”, U.S. Pat. No. 6,354,544] describes an adjustable camera-mounting device, wherein the camera-mounting member is rotatably movable within a base member and allowing the camera to be grippingly retained after the desired orientation has been attained. An advantage of this mounting device is that it permits infinite rotational positioning of the camera between horizontal and vertical positions, and vice versa. However, a disadvantage of this system is that it is meant particularly for the purpose of mounting camera, and does not have the facilities for rotation in the azimuth and tilt in the orientations other than vertical. Another limitation of this system is its inability to rigidly mount a device that may be subject to drag force under relative motion in a fluid medium (say, water/air).

Yet another system [M. V. Leyden, K. Kinnunen, and P. J. Knight (2002), “Adjustable Mounting Device”, U.S. Pat. No. 6,371,345] describes an adjustable mounting device for mounting a portable electronic device at a selected position relative to an interior surface of a vehicle. A limitation of the said mounting device is that although it might be suitable for mounting an electronic device within the interior surface of a vehicle, it does not have the capability for pan and tilt motions in numerous orientations, and is not designed to have the ability to withstand fluid dynamical forces.

Still another system [E. Holloway, Jr., (2002), “Equipment Support Assembly”, U.S. Pat. No. 6,412,426]describes an equipment support assembly having several plates with a plurality of openings for mounting equipment within a vehicle, the said assembly being removably se curable to the floor of a vehicle. A limitation of the said support assembly is that although it might be suitable for mounting an equipment within a vehicle, it does not have the capability for pan and tilt motions in a multiplicity of orientations, and is not designed to have the ability to withstand fluid dynamical forces.

Another system [R. G. Bodin (2002), “Mounting Apparatus Having A Swivel Head”, U.S. Pat. No. 6,443,680 {assigned to Illinois Tool Works Inc.}] describes a mounting apparatus having a cavity that is configured to allow coaxial rotation about a longitudinal axis. A limitation of the said apparatus is that although it provides an inwardly turned lip, the said device allows only limited swiveling, and it does not have the capability for pan and tilt motions in a multiplicity of orientations.

### OBJECTS OF THE INVENTION

The main object of the present invention is to provide a means for rigidly mounting any device such as an instrument, transducer, and so forth for measurement, simulation as well as examination of its dynamic performance.

Another object of the present invention is to facilitate rotation of any device such as an instrument, transducer, and so forth in the azimuthal direction at close angular intervals to permit pan motions, thereby enabling study of the azimuthal response of the instrument/transducer, and so forth under differing conditions.

Yet another object of the present invention is to facilitate tilting of any device such as an instrument, transducer, and so forth at pitch angles in the frontward and rearward directions to facilitate pitch motions.

Still another object of the present invention is to facilitate tilting of any device such as an instrument, transducer, and so forth at roll angles in the right-hand and left-hand directions to facilitate roll motions.

Another object of the present invention is to facilitate tilting of any device such as an instrument, transducer, and so forth at combined pitch-roll angles in the forward-, rearward-, left-hand-, and right-hand-directions to facilitate combined pitch-roll motions.

A further object of the present invention is to significantly minimize the influence of drag force during motion in fluid of any device such as an instrument, transducer, and so forth.

A still further object of the present invention is to provide a means for directing acoustic/electromagnetic beams in desired fixed orientations, inhibiting their swinging motions.

### SUMMARY OF THE INVENTION

In accordance with the aforesaid objectives, the present invention provides an adjustable mounting mechanism for rigidly mounting devices such as instruments, transducers and so forth, rotating such mounted devices at various angles in the azimuth direction and/or tilting such mounted device at various pitch angles, roll angles and combined pitch-roll angles to permit pan, pitch, roll and combined pitch-roll motion respectively of the device for measurement, simulation and examination of its dynamic performance in multiplicity of ways.

### DETAILED DESCRIPTION OF THE INVENTION

Accordingly, the present invention provides an adjustable mounting mechanism capable of pan, tilt, roll, and their combinations of the present invention provides for:

1. A means for rigidly mounting any device (such as an instrument, transducer, and so forth) for measurement, simulation, as well as examination of its dynamic performance in a multiplicity of ways in a manner it is used in its natural environment (e.g., when deployed from platforms such as country-crafts, ships, or drifting buoys that move over the sea-surface with all types of tilted motions under adverse wind/wave/current conditions; and when deployed from underwater vehicles and/or aircrafts that are prone to movement in all three dimensions with all types of tilted motions).

2. A means for facilitating rotation of the mounted device (such as an instrument, transducer, and so forth) in the azimuthal direction at a multiplicity of close angular intervals to permit simulation of pan motions, thereby enabling study of the azimuthal response of the instrument, transducer, and so forth under differing conditions which may be identical to the actual working condition of the mounted device (e.g., when deployed from anchored oceanographic and meteorological buoys that are free to rotate in the azimuthal direction over ±360° and also liable to undergo motions of differing nature under wind- and/or wave-induced forces).

3. A means for facilitating tilting of the mounted device (such as an instrument, transducer, and so forth) at pitch angles in the frontward and rearward directions to facilitate simulation of pitch motions which is similar to the original working conditions of the mounted device (e.g., when deployed from platforms such as country-crafts, ships, moored buoys, or drifting buoys that move over the sea-surface undergoing motions under pitch in the frontward and rearward directions).

4. A means for facilitating tilting of the mounted device (such as an instrument, transducer, and so forth) at roll angles in the right-hand and left-hand directions to facilitate simulation of the roll motions which resemble the actual working conditions of the mounted device (e.g., when deployed from marine platforms such as country-crafts, ships, moored buoys, and/or drifting buoys that move over the sea-surface undergoing motions under roll in the right-hand and left-hand directions; and when deployed from aircraft, rocket, meteorological buoys undergoing motions under roll in the right-hand and left-hand directions).

5. A means for facilitating tilting of any device (such as an instrument, transducer, and so forth) at combined pitch-roll angles in the forward-, rearward-, left-hand, and right-hand-directions to facilitate simulation of combined pitch-roll motions which resemble the actual working conditions of the mounted device (e.g., when deployed from marine platforms such as country-crafts, ships, moored buoys, and drifting buoys that moves over the sea-surface undergoing motions under combined pitch-roll angles in the forward-, rearward-, left-hand, and right-hand-directions to facilitate combined pitch-roll motions; and when deployed from meteorological platforms such as weather balloons that are liable to motions in all possible ways).

6. A means for mounting any device (such as an instrument, transducer, and so forth) in a manner that significantly minimizes the influence of drag force and wakes during motion in fluid (e.g., during calibration/performance evaluation experiments in flow flumes, wave flumes, and/or wind tunnels).

7. A means for directing acoustic/electromagnetic beams in desired fixed orientations, inhibiting their swinging motions.

Accordingly, the present invention provides an adjustable mounting mechanism capable of pan, tilt, roll, and their combinations, which comprises primarily of a planar plate member [19] for mounting any device such as an instrument, transducer, and the like; another planar plate member [20] having numerous preferably, although not necessarily, equally spaced perforations at specified angular separations drilled on its planar surface circumferentially along its periphery, two arc-shaped planar members [21] having numerous preferably, although not necessarily, equally spaced perforations at specified angular separations drilled along their planar surfaces, and a planar plate member [22] that is capable of being mounted rigidly on a support staff means [23], wherein the said support staff means [23] permits rotation of the planar plate member [19] and therefore the device mounted on it, about the axis of the said support staff means [23] in the azimuthal direction through ±360°.

In an embodiment of the present invention, wherein the planar plate member [19], which functions as an adjustable mounting means, is provided with several preferably, although not necessarily, radially-directed slots [30] to facilitate trouble-free attachment of any device to the said planar plate member [19] directly or with the use of suitable mounting brackets [not shown] that are convenient to employ with the device that is desired to be attached.

In another embodiment of the present invention, wherein several perforations [31] are provided on the periphery of the planar plate member [19] to permit orientation of the mounted device in any desired position/direction.

In yet another embodiment of the present invention, wherein the planar plate member [19] is attached to two planar plate members [32] with the use of two pairs of attachment means [33] that could preferably, although not necessarily, be bolts and matching nuts [34] that function as locking members.

In still another embodiment of the present invention, wherein the planar plate members [32] and the planar member [20] are hinged together with the use of a central rod [35] wherein the said central rod of the hinge mechanism is substantially co-axial with the axis of pitch-motion [36] so that the angle between them can be varied about the hinge in the chosen increments with the use of a pair of suitable coupling members [37] that are rigidly mounted between the said planar plate member [20] and the arc-shaped planar plate members [21], and held in position with the use of two nuts [38] and further strengthened by two lock-nuts [39], both of them functioning as locking members.

In one more embodiment of the present invention, the aforesaid mechanism permits tilting the device that is mounted on the planar plate member [19] from the vertical through chosen angular increments through frontward- or rearward-pitch-angles, thereby accomplishing symmetric motions in the frontward- and rearward pitch-motion direction, and enabling tilts under pitch motions.

In one another embodiment of the present invention, wherein the two projecting members [40] are provided on the planar member [22] and perforations [41] provided on the periphery of the flat surfaces of the planar plate member [20] enables tilting of the planar plate member [19] and therefore the device mounted on it, through chosen angular increments in both right-hand and left-hand roll directions about the axis of-roll-motion [42] that passes through the center of the planar members [20] and. [22], thereby accomplishing symmetric motions in the right-hand and left-hand roll directions, and enabling tilts under roll motions.

In a further embodiment of the present invention, wherein the said device also permits tilting the planar plate member [19] at combinations of a multitude of chosen roll- and pitch-angles through judicious choice of appropriate perforations provided on the arc-shaped members [21] and the planar member [20].

In an embodiment of the present invention, wherein the perforation that is centrally located on the arc-shaped planar plate member [21] defines the zero-pitch angle.

In another embodiment of the present invention, wherein the perforations that are located towards the end portion [43] of the arc-shaped members [21] define the negative pitch angles that increment in magnitude in preferably, although not necessarily, equal angular increments from the zero-pitch angle.

In yet another embodiment of the present invention, the perforations that are located towards the end portion [44] of the arc-shaped members [21] define the positive pitch angles that increment in magnitude in preferably, although Pot necessarily, equal angular increments from the zero-pitch angle.

In still another embodiment of the present invention wherein the perforations located on the longitudinal axis of the planar plate member [20] (which is parallel to the axis of pitch motion [36]) defines the zero-roll angle.

In one more embodiment of the present invention, wherein the perforations located towards the clockwise direction from the zero-roll angle position define the negative roll angles.

In one another embodiment of the present invention, the perforations that are located towards the counter-clockwise direction from the zero-roll angle position define the positive roll angles.

In a further embodiment of the present invention, wherein a protractor means [24] that is mounted on a plane, which is perpendicular to the axis of the support staff means [23] and whose central axis passing through the axis of the said support staff means [23], and rigidly held in position with the use of a threaded member [25], permits measurement of the azimuthal directions of any instrument, transducer, and the like that is mounted on the planar plate member [19].

In an embodiment of the present invention, the support staff means [23] is provided with sufficient number of extension collar means [26] that can slide along the exterior surface of the support staff means [23], and fixed on any desired location with the use of a fastening pin means [27].

In another embodiment of the present invention, an adjustable hook means [28], which is integrally joined to the collar means [26], and having an opening [not shown], which is directed parallel to the axis of the support staff means [23], allows easy passage and secure-holding of the electrical cable means [29] that might be used to connect the attached device, transducer, and the like to its remote electronic/electrical sub-system means [not shown].

In yet another embodiment of the present invention, the collar means [26] can be attached to the support staff means [23] by other conventional methods as well.

In still another embodiment of the present invention, a multiplicity of means other than the hook means [28] can be used to support the electrical cable means [29].

In one more embodiment of the present invention, the said mounting system can be attached to a support staff means [23] with the use of two clamp means [45], wherein the said clamp means may preferably, although not necessarily, be a C-shaped clamp means.

In one another embodiment of the present invention, each of these clamps means [45] is integrally joined to the planar plate member [22].

In a further embodiment of the present invention, each of these clamps means [45] is provided with a mating clamp means [46] which may preferably, although not necessarily, be a C-shaped clamp means.

In a still further embodiment of the present invention, fastening means [47] which may preferably, although not necessarily, be bolts and nuts means provided on each of the clamp means [45] and [46] allows rigid attachment of the said clamp means to the support staff means [23] with the use of a flexible-pad stiffener [48], which might preferably—although not necessarily—be a rubber pad means.

In an embodiment of the present invention, the said stiffener functions as a means for reinforcing the grip between the exterior surface of the support staff means [23] and the interior face of the clamp means [45] and [46].

In another embodiment of the present invention, the central rod [35] of the hinge mechanism is substantially co-axial with the axis of pitch-motion [36] and passes through the center of the arc-shaped pitch-motion control members [21].

In yet another embodiment of the present invention, the coupling members [37] that are rigidly attached on the top portion of the planar member [20] are substantially threaded bolt means that couple to the two arc-shaped members [21] through pairs of perforations on the said two members [21] and locked in position with the use of a pair of nut means [38] and lock nut means [39] on them.

In still another embodiment of the present invention, the perforations [41] drilled along the periphery of the planar surfaces of member [20] and those on the two arc-shaped members [21] are substantially circular to permit accuracy in the desired angles.

In one more embodiment of the present invention, the projecting members [37] and [40] prevent swinging motion of the planar member [19] and therefore the device mounted on it.

In one another embodiment of the present invention, the interconnecting member [49] is integrally joined to the planar members [32] to provide a rigid locating means to the arc-shaped members [21].

In a further embodiment of the present invention, the interconnecting member [52] serves the purpose of providing rigidity among the arc-shaped members [21].

In a still further embodiment of the present invention, the interconnecting members [49] and [52] and the arc-shaped members [21] are rigidly held in position with the use of locking means [50] and [51].

In an embodiment of the present invention, two relatively large circular portions carved out from the central portion of the flat members [20] and [22] substantially reduce motion-induced drag force during relative motion and/or dynamic testing in any fluid medium.

In another embodiment of the present invention, the edges of all the members are chamfered/rounded to reduce flow separation and vortex shedding during relative motion in any fluid medium.

In yet another embodiment of the present invention, the entire device is easy to be assembled and mounted, and is amenable to quick changes of angles, thereby serving as a time saver during test and evaluation experiments.

In still another embodiment of the present invention, all the members of the device are coated with a suitable protective material to allow its use in any environment.

In one more embodiment of the present invention, fixed slots/perforations provided on the planar members [20] and [21] for selection of tilt angles prevent any types of reciprocating motions of the mounted device under drag force.

In one another embodiment of the present invention, the mounting staff member [23] is located in the middle of the planar member [22] so that the drag force which act on the mounting device during its relative motion with respect to a fluid are equally distributed on either half of the mounting device and are perfectly balanced.

In a further embodiment of the present invention, chamfered surfaces provided to all the members of the mounting mechanism of the present invention enable safety of handling and ease of operation.

In a still further embodiment of the present invention, the recesses on the planar member [19] are preferably, although not necessarily, radially-oriented slits preferably, although not necessarily, emanating from its center, thereby providing adequate flexibility for mounting an instrument, transducer, and the like.

The above preferred embodiments have been described for the purpose of example only. The adjustable mounting mechanism capable of pan, tilt, roll, and their combinations of the present invention may be practiced in many other forms and in combination with other devices/members. The present invention may be particularly utilized in virtually any tow-tank facility for performance evaluation of motion-measuring devices, water current meters, and the like; and the mechanism's miniaturized form preferably, although not necessarily, may be utilized in any wind-tunnel facility for performance evaluation of motion-measuring and wind-measuring devices. Many changes could be made in the use of this invention as necessary to serve a particular application without departing from the spirit and scope of this invention. Therefore, these examples are not to be construed as limiting in any nature.

### BRIEF DESCRIPTION OF THE ACCOMPANYING DRAWINGS

In the drawings accompanying this specification:

FIG. 1 represents a system of the prior art used for tilting of a water-current meter for investigation of its tilt response.

FIG. 2 represents a system of the prior art used for rotating and tilting of a pressure transducer for examination of its azimuthal and pitch-angle tilt response under water flows and waves.

FIG. 3 shows the isometric front-view of the novel mounting system of the present invention used for rotating any device in the azimuthal direction through ±360° and tilting it under pitch-, roll-, and/or combined pitch-roll angles for any application.

FIG. 4 illustrates the isometric rear-view of the novel mounting system of the present invention used for rotating any device in the azimuthal direction through ±360° and tilting it under pitch-, roll-, and/or combined pitch-roll angles for any application.

FIG. 5 is a side-view of the mounting device of FIG. 3.

FIG. 6 is a rear-view of the mounting device of FIG. 3.

FIG. 7 is a front-view of the mounting device of FIG. 3.

FIG. 8 shows a typical example illustrating the usefulness of the novel mounting mechanism of the present invention, wherein the azimuthal response of a SonTek Argonaut Doppler Velocity Log. (Model: Argonaut type DL; serial # N60) obtained based on tow-tank experiments using the novel mounting mechanism of the present invention is shown.

FIG. 9 shows the pitch-angle tilt-response obtained using the novel mounting mechanism of the present invention.

FIG. 10 shows the roll-angle tilt-response obtained using the novel mounting mechanism of the present invention.

FIG. 11 shows the combined-pitch-roll angle tilt-response obtained using the novel mounting mechanism of the present invention.

The invention will now be described in detail with reference to the accompanying drawings which are given by way of illustration and hence, should not be construed to limit the scope of the invention

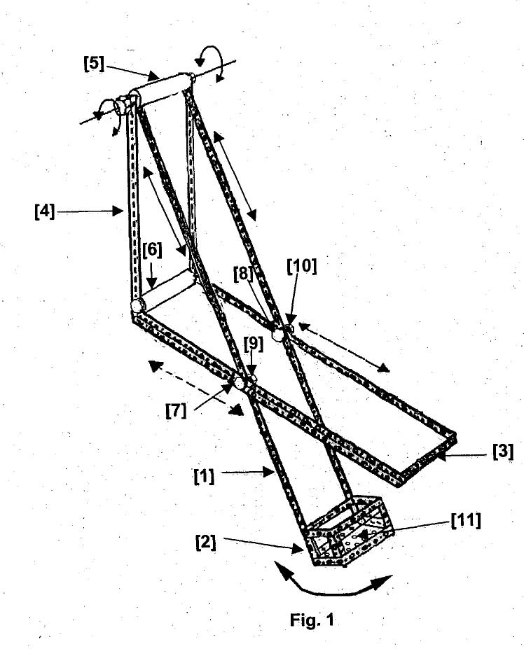

FIG. 1 represents a typical design example, showing a support mechanism of the prior art used by A. Joseph and E. Desa in “An Evaluation of Free- and Fixed-Vane Flowmeters with Curved- and Flat-Bladed Savonius Rotors”, Journal of Atmospheric and Oceanic Technology, American Meteorological Society, Vol. 11, No. 2, pp. 525-533 (1994), for tilting water-current meters for investigation of their tilt responses at differing towing speeds. This mechanism consists primary of a mounting bracket [1] having a base portion [2] for holding the instrument, transducer, and the like wherein the said mounting bracket [1] is securable to a support structure [3]. The mounting bracket [1] and the support structure [3] are coupled together through another bracket [4] via hinges [5] and [6] that are attached to the mounting bracket [1] and support structure [3] respectively. The said mounting bracket [1], base portion [2], support structure [3], and bracket [4] are all fabricated from commercially available slotted angles. The multiplicity of slots provided on the said slotted angles allows tilting the current meter, transducer, and the like through differing pitch angles with the use of bolt members [7] and [8] that are threadably engaged with nut members [9] and [10] respectively. The base plate member [11], which is provided with a multiplicity of perforations, permits mounting the current meter, transducer, and the like to the base portion [2]. An advantage of the mechanism of FIG. 1 is that it permits tilt of the transducer, instrument, or the like in the pitch direction. A limitation of the tilting mechanism of FIG. 1 is that it does not facilitate rotating the current meter, transducer, and the like in the azimuthal direction, nor giving it the capability for tilting the said devices in the roll direction.

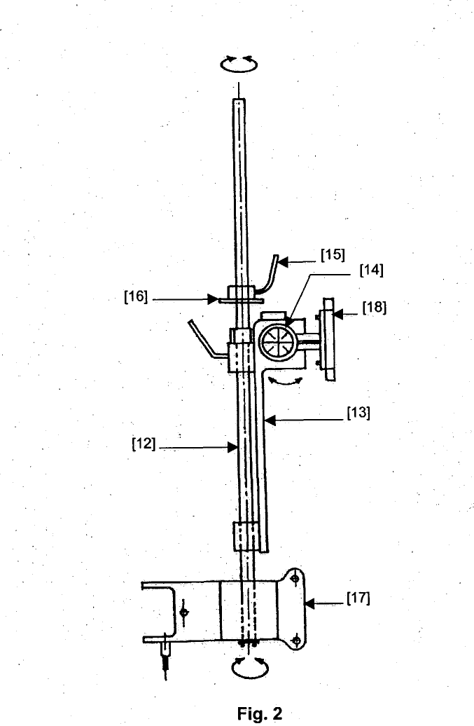

FIG. 2 represents another typical design example, showing a support mechanism of the prior art used by A. Joseph, J. A. E. Desa, P. Foden K. Taylor, J. McKeown, and E. Desa in “Evaluation and Performance Enhancement of A Pressure Transducer Under Flows, Waves, and A Combination of Flows and Waves”, Journal of Atmospheric and Oceanic Technology, American Meteorological Society, Vol. 17, No. 3 pp. 357-365 (2000) for tilting a pressure transducer for investigation of its azimuthal and tilt responses at differing towing speeds. This mechanism consists primarily of a mounting shaft [12] attached to a mounting shaft locating plate [13] which can be rotated along a vertical plane, wherein the rotation angle can be measured using a vertical protractor [14]. The mounting shaft [12] can be rotated in the azimuthal direction and locked in position using a friction-locking arrangement [15], wherein the azimuthal angle can be measured using a horizontal protractor [16]. An Aanderaa-make mounting unit [17] was used for mounting the pressure transducer, whose dynamical performance was to be evaluated. The planar member [18] permitted the whole mechanism to be attached to a suitable beam or structure [not shown]. An advantage of the mechanism of FIG. 2 is that it permits rotation of the transducer, instrument, or the like in the azimuthal direction and tilt in the pitch direction. However, a limitation of this mechanism is that it does not permit tilting the transducer, instrument, and the like through roll angle and combined pitch-roll angles.

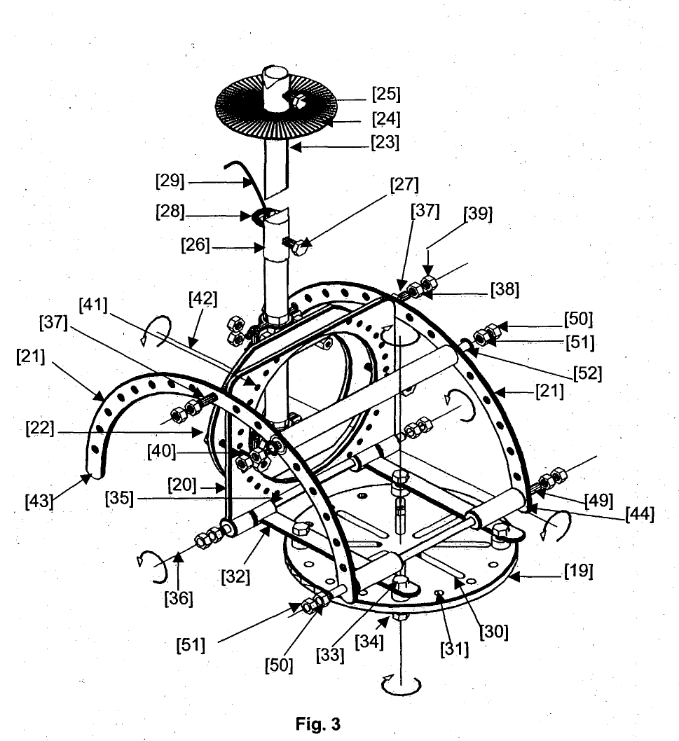

FIG. 3 is an isometric front-view of the improved mounting system of the present invention, which consists primarily of planar plate member [19] for mounting any device such as an instrument to be tested, another planar plate member [20] having numerous preferably, although not necessarily, equally spaced perforations drilled on its planar surface circumferentially along its periphery, two arc-shaped planar members [21] having numerous preferably, although not necessarily, equally spaced perforations drilled along their planar surfaces, and a planar plate member [22] that is capable of being mounted rigidly on a support staff means [23]. The said support staff means [23], permits rotation of the planar plate member [19] and therefore the device mounted on it, about the axis of the said support staff means [23] in the azimuthal direction through ±360°. A protractor means [24] that is mounted on a plane, which is perpendicular to the axis of the support staff means, [23] and whose central axis passing through the axis of the said support staff means [23], and rigidly held in position with the use of a threaded member [25] permits measurement of the azimuthal directions of any instrument, device, and the like that is mounted on the planar plate member [19]. The support staff means [23] is provided with sufficient number of extension collar means [26] that can slide along the exterior surface of the support staff means [23], and fixed on any desired location with the use of a fastening pin means [27]. An adjustable hook means [28], which is integrally joined to the collar means [26], and having an opening [not shown], which is directed parallel to the axis of the support staff means [23], allows easy passage and secure-holding of the electrical cable means [29] that might connect the attached device to its remote electronic/electrical sub-system means [not shown]. The collar means [26] can also be attached to the support staff means [23] by other conventional methods; and further, a multiplicity of means other than the hook means [28] can be used to support the electrical cable means [29]. The planar plate member [19], which functions as an adjustable mounting means, is provided with several radially-directed slots [30] to facilitate trouble-free attachment of any device to the said planar plate member [19] with the use of suitable mounting brackets [not shown] that are convenient to employ with the device that is desired to be attached. Several perforations [31] provided on the periphery of the planar plate member [19] permits orientation of the mounted device, transducer, and the like in, any desired position/direction. The planar plate member [19] is attached to two planar plate members [32] with the use of two pairs of attachment means [33] that could be preferably, although not necessarily, be bolts and matching nuts [34] that function as locking means. The planar plate members [32] and the preferably, although not necessarily, circular-shaped member [20] are hinged together with the use of a cylindrical-shaped central rod [35] wherein the said central rod of the hinge mechanism is substantially co-axial with the axis of pitch-motion [36] so that the angle between them can be varied about the hinge in the chosen increments with the use of a pair of suitable coupling members [37] that are rigidly mounted between the said planar plate member [20] and the arc-shaped planar plate members [21], and held in position with the use of two nut members [38] and further strengthened by two lock-nut members [39], both of them functioning as locking members. This permits tilting the device, transducer, and the like that is mounted on the planar plate member [19] from the vertical through chosen angular increments through frontward- or rearward-pitch-angles, thereby accomplishing symmetric motions in the frontward- and rearward-pitch-motion direction, and enabling simulation of tilts under pitch motions. The two projecting members [40] that are provided on the planar member [22] and the perforations [41] provided on the periphery of the flat surfaces of the planar plate member [20] enables tilting the planar plate member [19] and therefore the device, transducer, and the like mounted on it, through chosen angular increments in both right-hand and left-hand roll directions about the axis of roll-motion [42] that passes through the center of the planar members [20] and [22], thereby accomplishing symmetric motions in the right-hand and left-hand roll directions, and enabling simulation of tilts under roll motions. The device of the present invention also permits tilting the planar plate member [19] at combinations of a multitude of chosen roll- and pitch-angles through judicious choice of appropriate perforations provided on the arc-shaped members [21] and the planar member [20]. The interconnecting member [49] is integrally joined to the planar members [32] to provide a rigid locating means to the arc-shaped members [21], whereas the interconnecting member [52] serves the purpose of providing rigidity among the arc-shaped members [21]. The said members [49] and [52] and the arc-shaped member [21] are rigidly held in position with the use of locking means [50] and [51].

The perforation that is centrally located on the arc-shaped planar plate member [21] defines the zero-pitch angle. Those perforations that are located towards the end portion [43] of the arc-shaped members [21] define the negative pitch angles that increment in magnitude in preferably, although not necessarily, equal angular increments from the zero-pitch angle. In a similar manner, those perforations that are located towards the end portion [44] of the arc-shaped members [21] define the positive pitch angles that increment in magnitude in preferably, although not necessarily, equal angular increments from the zero-pitch angle. The perforations those are located on the axis of the planar plate member [20], which is parallel to the pitch motion axis [36] defines the zero-roll angle. Those perforations that are located towards the clockwise direction from the zero-roll angle position define the negative roll angles that increment in magnitude in preferably, although not necessarily, equal angular increments from the zero-roll angle. In a similar manner, those perforations that are located towards the counter-clockwise direction from the zero-toll angle position define the positive roll angles that increment in magnitude in preferably, although not necessarily, equal angular increments from the zero-roll angle.

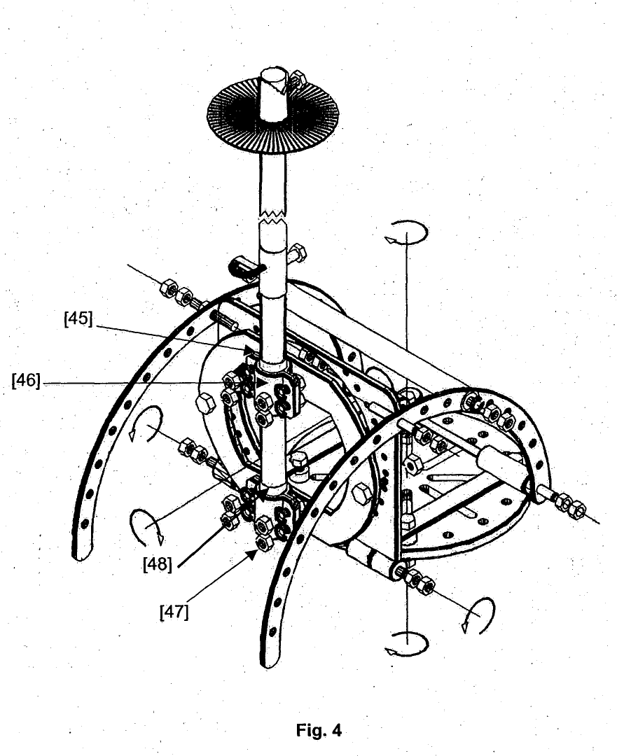

FIG. 4 illustrates the isometric rear-view of the novel mounting mechanism of the present invention used for rotating any device in the azimuthal direction through ±360° and tilting it under pitch-, roll-, and/or combined pitch-roll angles for any application, wherein the said mounting mechanism can be attached to the support staff means [23] with the use of a clamp means [45] which is integrally joined to the planar member [22] and provided with a mating clamp means [46] which in turn may preferably, although not necessarily, be a C-shaped clamp means. The fastening means [47] which may preferably, although not necessarily, be bolts and nuts members that are provided on each of the clamp means [45] and [46] allows rigid attachment of the said clamp means to the support staff means [23] with the use of a flexible-pad stiffener [48], which might preferably—although not necessarily—be a rubber pad means.

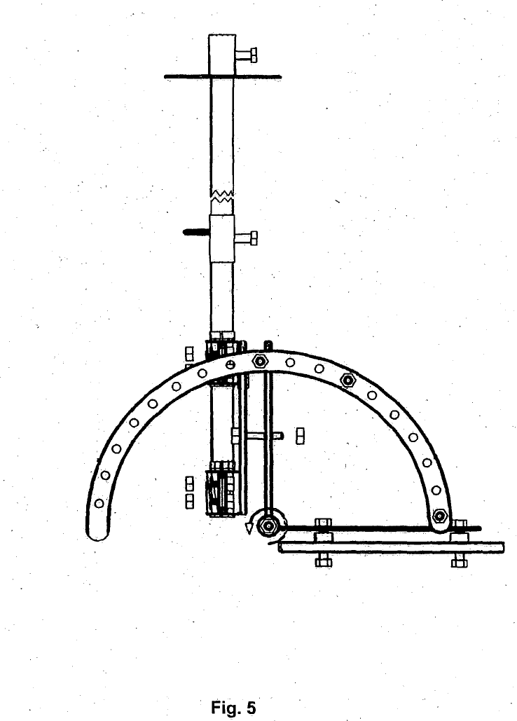

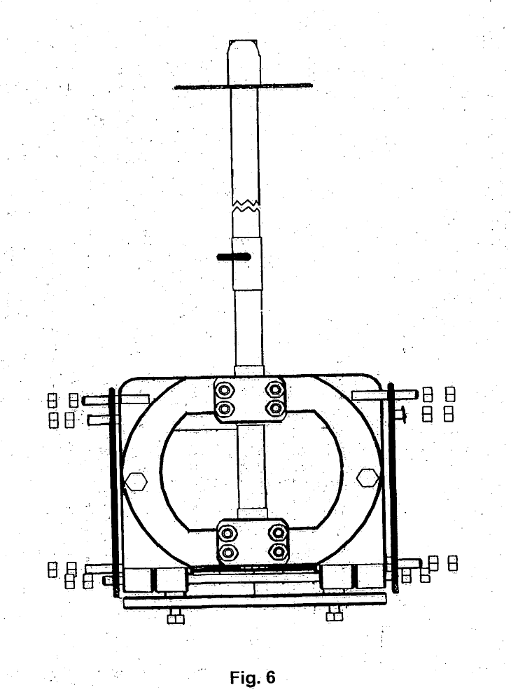

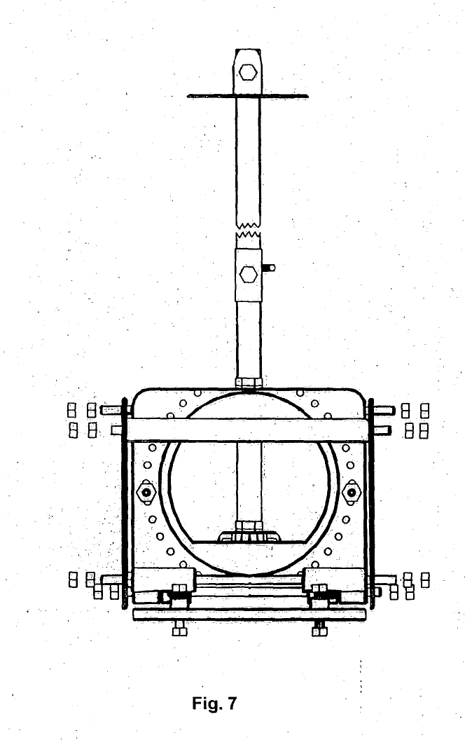

The side-view, the rear view and the front view of the mounting device of FIG. 3 are shown in FIGS. 5, 6 and 7 respectively.

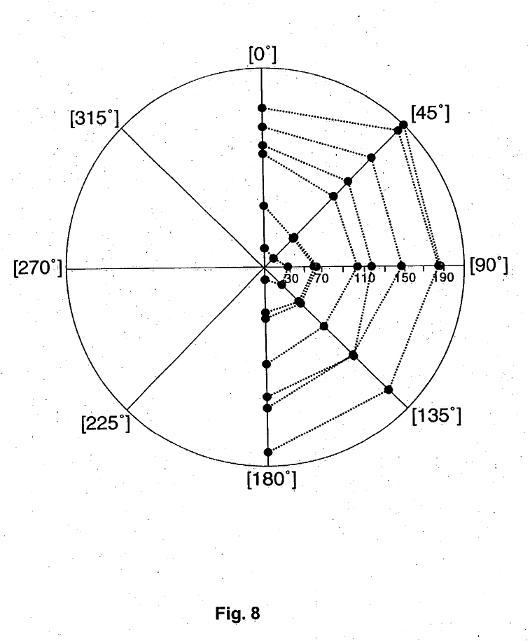

FIG. 8 shows a typical example illustrating the usefulness of the improved mounting mechanism of the present invention, wherein the azimuthal response of a SonTek Argonaut Doppler Velocity Log (Model: Argonaut type DL; serial # N60) obtained based on tow-tank experiments using the mechanism of the present invention is shown, although use of any other type of instrument/transducer does not limit the scope of the present invention.

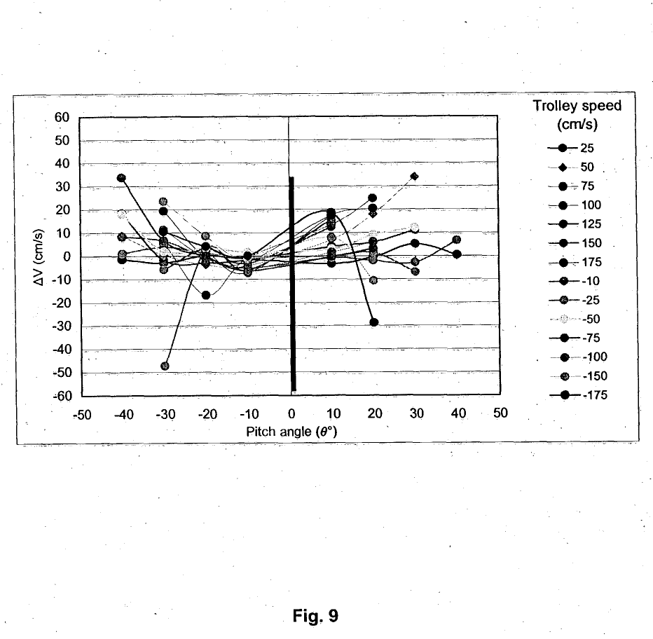

FIG. 9 shows the pitch-angle tilt-response obtained using the system of the present invention, wherein [ΔV] represents the deviation of the DVL's speed output at various pitch angles from the corresponding output at normal attitude at differing towing speeds.

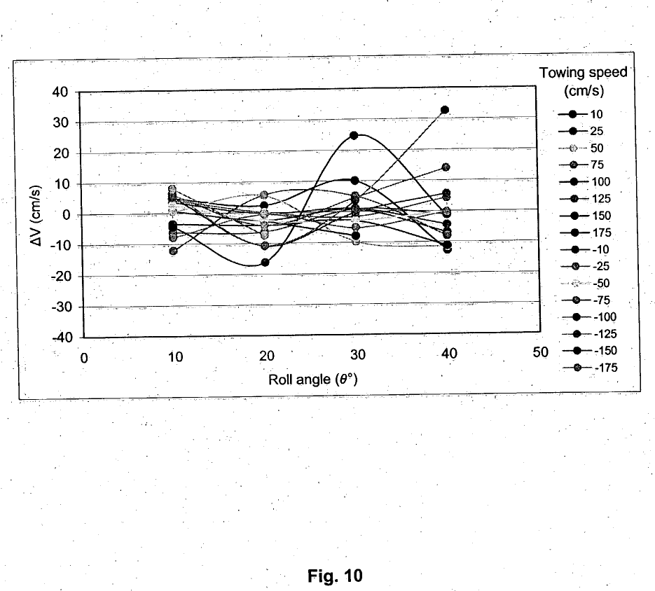

FIG. 10 shows the roll-angle tilt-response obtained using the system of the present invention, wherein [ΔV] represents the deviation of the DVL's speed output at various roll angles from the corresponding output at normal attitude at differing towing speeds.

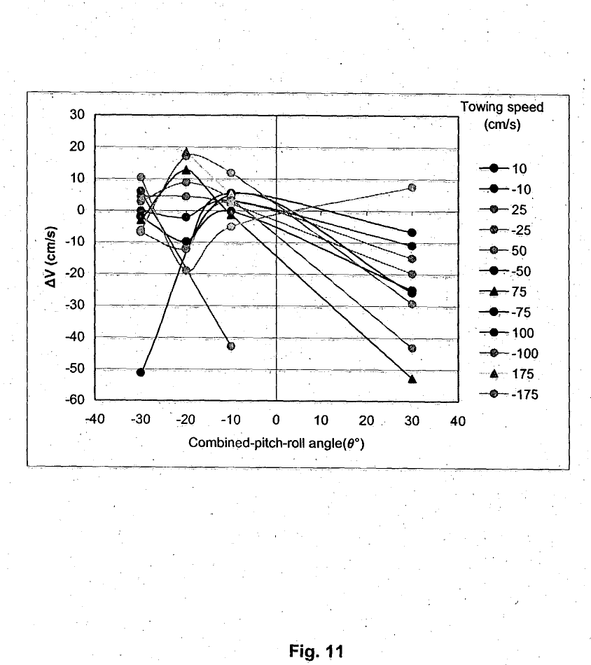

FIG. 11 shows the combined-pitch-roll angle tilt-response obtained using the system of the present invention, wherein [ΔV] represents the deviation of the DVL's speed output at various combined-pitch-roll angles from the corresponding output at normal attitude at differing towing speeds.

The main advantages of the present invention are:

1. It provides a means for simulation and/or dynamic performance testing of any device, transducer, or the like by locating it on a mounting mechanism that is rigid and free from swinging motions.

2. It facilitates simulation and/or dynamic performance testing of any device, transducer, or the like in a fluid medium such as water/air by locating it on a rigid mounting mechanism that provides minimal drag force under relative motions between the said device, transducer, or the like and the fluid medium.

3. It facilitates simulation and/or dynamic performance testing of any device, transducer, or the like in a fluid medium such as water/air by locating it on a rigid mounting mechanism that causes minimal wake formation and vortex shedding under relative motions between the device, transducer, or the like and the fluid medium.

4. It provides a mechanism that is capable of easy assembly and mounting, thereby serving as a time saver during test and evaluation experiments on the device, transducer, or the like that is used in any fluid medium such as water and air.

5. It provides a mechanism that is amenable to quick changes of angles in the pitch, roll, and combined pitch-roll directions.

6. It provides a means to direct acoustic/electromagnetic beams in desired fixed orientations, inhibiting their swinging motions.

7. It is free from complicated and cumbersome mechanical members.

8. The mounting mechanism is sturdy and can be economically constructed from any suitable materials by conventional fabrication methods.

9. It is a purely mechanical device, which does not require the use of cumbersome electrical devices such as motors.

1. An adjustable mounting mechanism capable of pan, tilt, roll, and their combinations, comprising a primary planar plate member [19] for mounting any device such as an instrument/transducer or any other device to be tested, a secondary planar plate member [20] having numerous preferably, although not necessarily, equally spaced perforations drilled on its planar surface circumferentially along its periphery, two arc-shaped planar members [21] having numerous preferably, although not necessarily, equally spaced perforations drilled along their planar surfaces, and a tertiary planar plate member [22] that is capable of being mounted rigidly on a support staff means [23].

2. An adjustable mounting mechanism as claimed in claim 1, wherein the support staff means [23] permits rotation of the primary planar plate member [19] and therefore the device mounted on it, about the axis of the said support staff means [23] in the azimuthal direction through ±360°.

3. An adjustable mounting mechanism as claimed in claim 1, wherein the primary planar plate member [19], functioning as an adjustable mounting means, is provided with several radially-directed slots [30] to facilitate trouble-free attachment of any device using mounting brackets.

4. An adjustable mounting mechanism as claimed in claim 1, wherein plurality of perforations [31] are provided on the periphery of the primary planar plate member [19] and the perforations permit orientation of the mounted device in any desired position/direction.

5. An adjustable mounting mechanism as claimed in claim 1, wherein the planar plate member [19] is further attached to two other quaternary planar plate members [32] through attachment means [33] that could preferably, although not necessarily, be bolts and matching nuts means [34] that function as locking members.

6. An adjustable mounting mechanism as claimed in claim 1, wherein the quaternary planar plate members [32] and the secondary planar plate member [20] which is preferably of substantial circular cross-section are hinged together with the use of a cylindrical-shaped central rod member [35].

7. An adjustable mounting mechanism as claimed in claim 1, wherein a first interconnecting member [49] is integrally joined to the quaternary planar members [32] to provide a rigid locating means to the two arc-shaped planar members [21].

8. An adjustable mounting mechanism as claimed in claim 1, wherein a second interconnecting member [52] connected between the arc shaped planar members [21] serves the purpose of providing rigidity among the arc-shaped members [21].

9. An adjustable mounting mechanism as claimed in claim 1, wherein the said first and the second interconnecting members [49] and [52] and the arc-shaped planar members [21] are rigidly held in position using locking means [50] and [51].

10. An adjustable mounting mechanism as claimed in claim 6, wherein the cylindrically-shaped central rod member [35] of the hinge mechanism is substantially co-axial with the axis of pitch-motion [36] so that the angle between the same can be varied about the hinge in predetermined increments with the use of a pair of coupling members [37].

11. An adjustable mounting mechanism as claimed in claim 10, wherein the coupling members are rigidly mounted between the secondary planar plate member [20] and the arc-shaped planar plate members [21], and held in position with the use of two nut means [38] and further strengthened by two lock-nut means [39], both of them functioning as locking members.

12. An adjustable mounting mechanism as claimed in claim 11, wherein the coupling members rigidly mounted between the secondary planar plate member [20] and the arc-shaped planar plate members [21], permits tilting of the device mounted on the planar plate member [19] from vertical through chosen angular increments through frontward- or rearward-pitch-angles.

13. An adjustable mounting mechanism as claimed in claim 11, wherein the coupling members rigidly mounted between the secondary planar plate member [20] and the arc-shaped planar plate members [21], enable accomplishment of symmetric motions of the mounted device in the frontward- and rearward-pitch-motion direction, and enables tilts under pitch motions.

14. An adjustable mounting mechanism as claimed in claim 1, wherein two projecting members [40] are provided on the tertiary planar member [22] and perforations [41] are provided on the periphery of the flat surfaces of the secondary planar plate member [20].

15. An adjustable mounting mechanism as claimed in claim 14, wherein the projecting members [40] provided on the tertiary planar member [22] and perforations [41] provided on the secondary planar plate member enables tilting the planar plate member [19] and therefore the device mounted on it, through chosen angular increments in both right-hand and left-hand roll directions about the axis of roll-motion [42] that passes through the center of the secondary and tertiary planar members [20] and [22].

16. An adjustable mounting mechanism as claimed in claim 1, wherein the mounting mechanism is capable of accomplishing symmetric motions in the right-hand and left-hand roll directions, and enabling tilts under roll motions.

17. An adjustable mounting mechanism as claimed in claim 1, wherein the mounting mechanism permits tilting the planar plate member [19], at combinations of a multiplicity of chosen roll- and pitch-angles through judicious choice of appropriate perforations provided on the arc-shaped members [21] and the secondary planar member [20].

18. An adjustable mounting mechanism as claimed in claim 1, wherein the perforation located centrally on the arc-shaped planar plate member [21] defines the zero-pitch angle.

19. An adjustable mounting mechanism as claimed in claim 1 wherein perforations located towards an end portion [43] of the arc-shaped members [21] define negative pitch angles that increment in magnitude in preferably, although not necessarily, equal angular increments from the zero-pitch angle.

20. An adjustable mounting mechanism as claimed in claim 1, wherein perforations located towards an end portion [44] of the arc-shaped members [21] define positive pitch angles that increment in magnitude in preferably, although not necessarily, equal angular increments from the zero-pitch angle.

21. An adjustable mounting mechanism as claimed in claim 1, wherein perforations located on the axis of the planar plate member [20] defines the zero-roll angle.

22. An adjustable mounting mechanism as claimed in claim 1, wherein perforations located towards a clockwise direction from the zero-roll angle position define negative roll angles that increment in magnitude in preferably, although not necessarily, equal angular increments from the zero-roll angle.

23. An adjustable mounting mechanism as claimed in claim 1, wherein perforations located towards a counter-clockwise direction from the zero-roll angle position define positive roll angles that increment in magnitude in preferably, although not necessarily, equal angular increments from the zero-roll angle.

24. An adjustable mounting mechanism as claimed in claim 1, wherein a protractor means [24] mounted on a plane, which is perpendicular to the axis of the support staff means [23] and whose central axis passing through the axis of the said support staff means [23], and rigidly held in position with the use of a threaded member [25], permits measurement of the azimuthal directions of device mounted on the planar plate member [19].

25. An adjustable mounting mechanism as claimed in claim 1, wherein the support staff means [23] is provided with sufficient number of extension collar means [26] that can slide along the exterior surface of the support staff means [23], and fixed at any desired location with the use of a fastening pin means [27].

26. An adjustable mounting mechanism as claimed in claim 1, wherein an adjustable hook means [28], which is integrally joined to the collar means [26], and having an opening which is directed parallel to the axis of the support staff means [23], allows easy passage and secure-holding of the electrical cable means [29] that might connect the mounted device to its remote electronic/electrical sub-system means.

27. An adjustable mounting mechanism as claimed in claim 1, wherein the collar means [26] can also be attached to the support staff means [23] by other conventional methods.

28. An adjustable mounting mechanism as claimed in claim 1, wherein a multiplicity of means other than the hook means [28] can be used to support the electrical cable means [29].

29. An adjustable mounting mechanism as claimed in claim 1, wherein the said mounting mechanism can be attached to the support staff means [23] with the use of two pairs of clamp means [45] and [46], wherein the said clamp means may preferably, although not necessarily, be C-shaped clamps.

30. An adjustable mounting mechanism as claimed in claim 1, wherein the clamp means [45] is integrally joined to the tertiary planar plate member [22].

31. An adjustable mounting mechanism as claimed in claim 1, wherein said clamp means are rigidly attached to the support staff member [23] using a flexible-pad stiffener member [48], which might preferably—although not necessarily—be made of rubber.

32. An adjustable mounting mechanism as claimed in claim 31, wherein the stiffener functions as a means for reinforcing the grip between the exterior surface of the support staff means [23] and the interior faces of the clamp means [45] and [46].

33. An adjustable mounting mechanism as claimed in claim 6, wherein the central rod means [35] of the hinge mechanism is substantially co-axial with the axis of pitch-motion [36] and passes through the center of the arc-shaped pitch-motion control members [21].

34. An adjustable mounting mechanism as claimed in claim 10, wherein the coupling members [37] that are rigidly attached on a top portion of the secondary planar member [20] are substantially threaded bolt means that couple to the two arc-shaped members [21] through pairs of perforations on the said two members [21] and locked in position with the use of a pair of nut means [38] and lock nut means [39] on them.

35. An adjustable mounting mechanism as claimed in claim 1, wherein the perforations [41] drilled along the periphery of the surfaces of secondary planar member [20] and those on the two arc-shaped members [21] are substantially circular to permit accuracy in the desired angles.

36. An adjustable mounting mechanism as claimed in claim 1, wherein the projecting members [37] and [40] prevent swinging motion of the planar member [19] and therefore the device mounted on it, thereby permitting evaluation experiments under controlled dynamic conditions with the desired angular orientations.

37. An adjustable mounting mechanism as claimed in claim 1, wherein two substantially large circular portions carved out from the central portion of the planar members [20] and [22]substantially reduce motion-induced drag force during dynamic testing of the transducer, instrument, and the like in any fluid medium.

38. An adjustable mounting mechanism as claimed in claim 1, wherein the edges of all the members are chamfered/rounded to reduce flow separation and vortex shedding during dynamic testing in any fluid medium, of the device mounted on the member [19].

39. An adjustable mounting mechanism as claimed in claim 1, wherein the entire mechanism is easy to be assembled and mounted, and is amenable to quick changes of angles, thereby serving as a time saver during test and evaluation experiments.

40. An adjustable mounting mechanism as claimed in claim 1, wherein all the members of the said mechanism are coated to allow its use in any environment.

41. An adjustable mounting mechanism as claimed in claim 1, wherein fixed slots for selection of tilt angles prevent any types of reciprocating motions of the mounted device under drag force.

42. An adjustable mounting mechanism as claimed in claim 1, wherein the mounting staff member [23] is located in the middle of the planar member [22] so that the drag force which act on the mounting device during its relative motion with respect to a fluid are equally distributed on either half of the mounting mechanism and are perfectly balanced.

43. An adjustable mounting mechanism as claimed in claim 1, wherein chamfered surfaces provided to the members of the mounting mechanism enable smoothness of handling and ease in operation.

44. An adjustable mounting mechanism as claimed in claim 1, wherein the recesses on the mounting member [19] are preferably, although not necessarily, radially-oriented slits emanating from the center of the said mounting-platform [19]; thereby providing adequate space and flexibility for mounting of the device on the said platform.

45. An adjustable mounting mechanism as claimed in claim 1, wherein the mounting mechanism can be utilized in tow-tank facility for performance evaluation of motion-measuring devices, transducer, instrument, and the like and water current meters and wind-tunnel facility for performance evaluation of motion-measuring and wind-measuring devices.
